(19) United States
(12) Patent Application Publication
(10) Pub. No.: US 2014/0168163 A1
(43) Pub. Date: Jun. 19, 2014

(54) OPTICAL TOUCH SENSING STRUCTURE

(71) Applicants: Ming-Huei Yang, Hsinchu City (TW); Hsien-Ching Chang, New Taipei City (TW)

(72) Inventors: Ming-Huei Yang, Hsinchu City (TW); Hsien-Ching Chang, New Taipei City (TW)

(73) Assignee: SUBTRON TECHNOLOGY CO., LTD., Hsinchu County (TW)

(21) Appl. No.: 13/854,129

(22) Filed: Mar. 31, 2013

(30) Foreign Application Priority Data
Dec. 13, 2012 (TW) 101147284

(51) Int. Cl. G06F 3/042

(52) U.S. Cl. CPC G06F 3/0421
USPC 345/175

(57) ABSTRACT

An optical touch sensing structure includes a transparent substrate, a transparent adhesive layer and a plurality of transparent optical spheres. The transparent substrate has a top surface, and the transparent adhesive layer is disposed on the top surface of the transparent substrate. The transparent adhesive layer includes a plurality of adhesive portions. The adhesive portions are separate from one another and expose a portion of the top surface. The transparent optical spheres are disposed on the adhesive portions. The transparent optical spheres at each adhesive portion are arranged as a single layer, and the transparent optical spheres are fixed on the transparent substrate via the adhesive portions. When an infrared ray reaches each transparent optical sphere, the infrared ray is retroreflected and reflected by each transparent optical sphere.

### CROSS-REFERENCE TO RELATED APPLICATION

This application claims the priority benefit of Taiwan application serial no. 101147284, filed on Dec. 13, 2012. The entirety of the above-mentioned patent application is hereby incorporated by reference herein and made a part of this specification.

### BACKGROUND OF THE INVENTION

1. Field of the Invention

The present invention relates to a touch sensing structure, and more particularly relates to an optical touch sensing structure.

2. Description of Related Art

The current designs of the touch display panels are generally categorized, based on their touch sensing principles, into resistive, capacitive, optical, sound wave, and electromagnetic touch display panels. At present, the optical touch panels employ infrared rays as the light source and the charge coupled devices (CCDs) or CMOS optical sensors as the detectors for sensing the infrared rays so as to calculate the position of the touching points.

The optical touch apparatus employs the infrared diode to emit the infrared ray and the infrared ray is reflected by the reflecting component to the light sensing component in order to calculate the position of the touching point. However, the angle of the incoming infrared ray has to be carefully designed to match the location of the light sensing component to ensure the reflected infrared ray, after being reflected by the reflecting component, being received accurately by the light sensing component. Hence, the design flexibility of the arrangement of the infrared diode and/or the light sensing component is constrained.

### SUMMARY OF THE INVENTION

The present invention provides an optical touch sensing structure, which is capable of calculating the position of the touching point(s) through the retroflection and reflection of the infrared ray by the transparent optical sphere(s) of the optical touch sensing structure.

The present invention provides an optical touch sensing structure, including a transparent substrate, a transparent adhesive layer and a plurality of transparent optical spheres. The transparent substrate has a top surface, and the transparent adhesive layer is disposed on the top surface of the transparent substrate. The transparent adhesive layer includes a plurality of adhesive portions. The adhesive portions are separate from one another and expose a portion of the top surface. The transparent optical spheres are disposed on the adhesive portions. The transparent optical spheres on each adhesive portion are arranged as a single layer, and the transparent optical spheres are fixed on the transparent substrate via the adhesive portions. When an infrared ray reaches each transparent optical sphere, the infrared ray is retroreflected and reflected by each transparent optical sphere.

According to the embodiment, a refractive index of each of the plurality of transparent optical spheres ranges from 1.9 to 5.0, and a refractive index of each of the plurality of transparent optical spheres is greater than a refractive index of the transparent substrate.

According to the embodiment, a diameter of each of the plurality of transparent optical spheres ranges from 10 microns to 100 microns.

According to the embodiment, a material of each of the plurality of transparent optical spheres includes a transparent oxide material.

According to the embodiment, the optical touch sensing structure further comprises a transparent positioning layer disposed on the top surface of the transparent substrate. A refractive index of the transparent positioning layer is smaller than a refractive index of the plurality of transparent optical spheres. The transparent positioning layer includes a plurality of transparent positioning portions covering the portion of the top surface that is exposed by the plurality of adhesive portions, and the plurality of transparent positioning portions restrict locations of the plurality of transparent optical spheres on the plurality of adhesive portions.

According to the embodiment, a top surface of each of the plurality of transparent positioning portion is lower than a top end of each of the plurality of transparent optical spheres, and a material of the transparent positioning layer includes an ultraviolet photoresist material or a flexible material.

According to the embodiment, the optical touch sensing structure further comprises a transparent protection layer disposed over the plurality of transparent optical spheres. A bottom surface of the transparent protection layer is in contact with a top end of each of the plurality of transparent optical spheres.

According to the embodiment, a refractive index of the transparent protection layer is smaller than a refractive index of each of the plurality of transparent optical spheres, and a thickness of the transparent protection layer ranges from 0.1 millimeter to 1 millimeter.

According to the embodiment, the optical touch sensing structure further comprises a transparent optical matching layer disposed on the top surface of the transparent substrate. A refractive index of the transparent optical matching layer is smaller than a refractive index of each of the plurality of transparent optical spheres, and the transparent optical matching layer includes a plurality of transparent optical matching portions covering the portion of the top surface that is exposed by the plurality of adhesive portions.

According to the embodiment, the transparent protection layer is in contact with a top surface of each of the plurality of transparent optical matching portions.

In view of above, the optical touch sensing structure of the present invention has transparent optical spheres, when a touch device (such as an optical touch stylus) emits an infrared ray to the optical touch sensing structure, the transparent optical spheres can retroreflect and reflect the infrared ray to the infrared camera of the touch device, so as to calculate the position of the touching point(s).

Since the transparent optical spheres have dual functions of retroreflection and reflection, the reflected infrared ray propagates toward the light source and the reflected infrared ray also propagates toward a plurality of directions. The infrared camera may be installed at the location(s) adjacent to the infrared light source to receive the infrared ray retroreflected back by the transparent optical spheres, or installed at other locations to receive the reflected infrared ray propagating toward the other directions. Hence, there is no need to limit the incident angle of the infrared ray of the touch device and the position of the infrared camera. As a result, when the touch device works with the optical touch sensing structure of this invention, the touch device can work with a larger range of operation angles and better operation flexibility.

In order to make the aforementioned and other objects, features and advantages of the present invention comprehensible, a preferred embodiment accompanied with Figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a cross-sectional view of an optical touch sensing structure according to an embodiment of the present invention.

FIG. 2 schematically illustrates a cross-sectional view of an optical touch sensing structure according to another embodiment of the present invention.

FIG. 3 schematically illustrates a cross-sectional view of an optical touch sensing structure according to one embodiment of the present invention.

FIG. 4 schematically illustrates a cross-sectional view of an optical touch sensing structure according to another one embodiment of the present invention.

### DESCRIPTION OF EMBODIMENTS

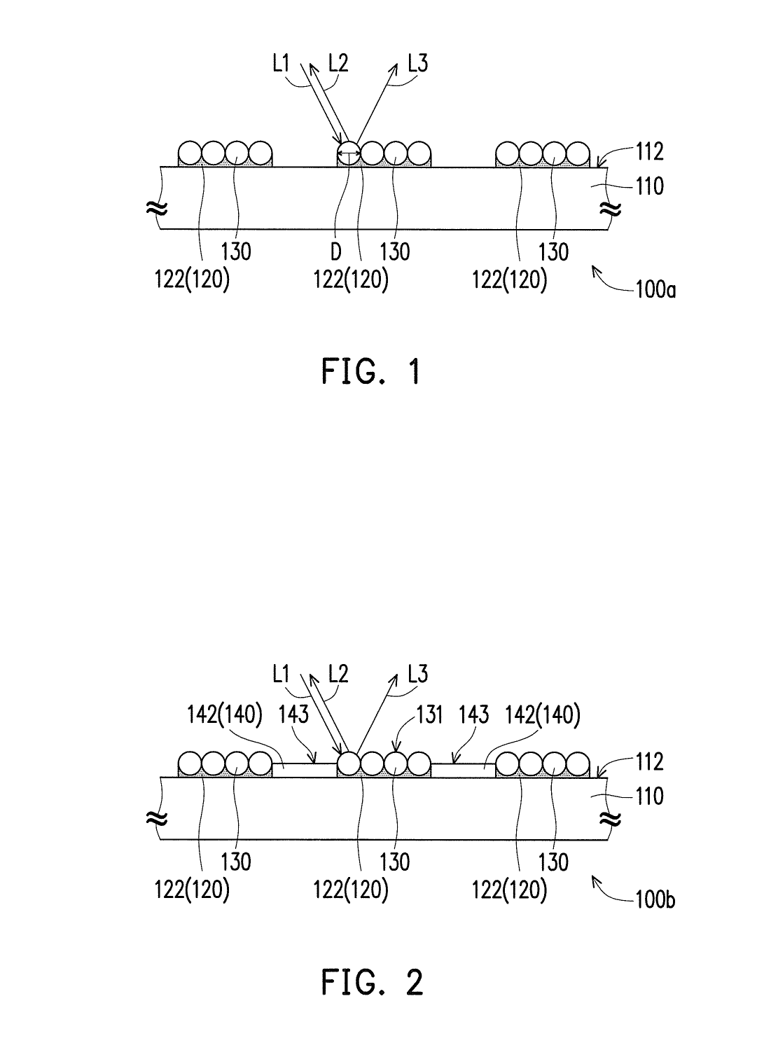

FIG. 1 schematically illustrates a cross-sectional view of an optical touch sensing structure according to an embodiment of the present invention. Referring to FIG. 1, the optical touch sensing structure 100a includes a transparent substrate 110, a transparent adhesive layer 120 and a plurality of transparent optical spheres 130. The refractive index of the transparent substrate 110 is substantially equivalent to the refractive index of the transparent adhesive layer 120, and the refractive index of each of the transparent optical spheres 130 is greater than the refractive index of the transparent substrate 110 and the refractive index of the transparent adhesive layer 120. The transparent substrate 110 includes a top surface 112 and the transparent adhesive layer 120 is disposed on the top surface 112 of the transparent substrate 110. The transparent adhesive layer 120 includes a plurality of adhesive portions 122, and the adhesive portions 122 are separate from one another so as to expose portions of the top surface 112. The transparent optical spheres 130 are disposed on the adhesive portions 122. For each adhesive portion 122, the transparent optical spheres 130 are attached onto the adhesive portion in a single layer. Hence, the transparent optical spheres 130 are fixed to the transparent substrate 110 through the transparent adhesive layer 120. When the incident infrared ray L1 reaches on any one of the transparent optical spheres 130, each transparent optical sphere 130 retroreflects the infrared ray L1 (becoming the infrared ray L2 in FIG. 1) and reflects the infrared ray L1 (becoming the infrared ray L3 in FIG. 1). Due to the high refractive index and geometric characteristics of the transparent optical sphere(s) 130, the retroreflected infrared ray L2 propagates toward the light source (not shown), while the reflected infrared ray L3 propagates toward a plurality of other directions.

In details, the material of the transparent substrate 110 may be plastic, glass, polymethylmethacrylate (PMMA) or other highly transparent materials. The material of the transparent adhesive layer 120 may be a transparent optical adhesive material. The locations of the adhesive portions 122 of the transparent adhesive layer 120 define the allocation locations of the transparent optical spheres 130. In this embodiment, the refractive index of each of the transparent optical spheres 130 ranges from 1.9 to 5.0, and the diameter D of each of the transparent optical spheres 130 ranges from 10 microns to 100 microns, for example. The material of the transparent optical spheres 130 may be transparent oxide materials, such as, bismuth oxide (Bi₂O₃), zinc oxide (ZnO), titanium oxide (TiO₂), tin oxide (SnO₂), tungsten oxide (WO₃), cerium oxide (CeO₂), hafnium oxide (HfO₂), tantalum oxide (Ta₂O₅), holmium oxide (Ho₂O₃), indium tin oxide (ITO), niobium oxide (Nb₂O₅), indium oxide (In₂O₃), neodymium (Nd₂O₃), antimony oxide (Sb₂O₃) or zirconium oxide (ZrO₂), but is not limited to the examples described herein.

In this embodiment, for the optical touch sensing structure 100a having a plurality of transparent optical spheres 130, when the touch device (such as an optical touch stylus) emits the infrared ray L1 and reaches the optical touch sensing structure 100a, the transparent optical spheres 130 can retroreflect the infrared ray L1 (becoming the infrared ray L2 in FIG. 1) and reflect the infrared ray L1 (becoming the infrared ray L3 in FIG. 1) to be received by the infrared camera (not shown) of the touch device, so that the position of the touch point can be calculated. Since the transparent optical spheres 130 have dual functions of retroreflection and reflection and the reflected infrared ray L3 propagates toward a plurality of directions, there is no need to limit the incident angle of the infrared ray L1 of the touch device and the position of the infrared camera. That is, the infrared camera may be installed at the location(s) adjacent to the infrared light source to receive the infrared ray L2 retroreflected back by the transparent optical spheres 130 (parallel to the path of the infrared L1), or installed at other locations to receive the reflected infrared ray L3 propagating toward the other directions. Hence, the incident angle of the infrared ray L1 of the touch device needs not to be limited, and it is unlikely that the infrared camera fails to receive the retroreflected infrared ray L2 or reflected infrared ray L3. As a result, when the touch device works with the optical touch sensing structure 100a of this invention, the touch device can work with a larger range of operation angles and better operation flexibility.

In the following embodiment(s), certain reference numbers and related contexts of some elements or components in the previous embodiment will be used again and the same reference numbers will be used to describe the same or similar elements or components and the related descriptions of the same technology may be omitted.

FIG. 2 schematically illustrates a cross-sectional view of an optical touch sensing structure according to another embodiment of the present invention. Referring to FIG. 2, the optical touch sensing structure 100b is similar to the optical touch sensing structure 100a of FIG. 1, and the main differences are discussed as follows. The optical touch sensing structure 100b further includes a transparent positioning layer 140 disposed on the top surface 112 of the transparent substrate 110. The transparent positioning layer 140 includes a plurality of transparent positioning portions 142. The transparent positioning portions 142 covers the top surface 112 of the transparent substrate 110 that is exposed by the adhesive portions 122 of the transparent adhesive layer 120, and the transparent positioning portions 142 restrict the locations of the transparent optical spheres 130 on the adhesive portions 122. The top surface 143 of each transparent positioning portion 142 is lower than the top end 131 of each transparent optical sphere 130 so as to have a larger incident surface area when the incident infrared ray L1 reaches on the transparent optical spheres 130. Herein, the material of the transparent positioning layer 140 may be an ultraviolet photoresist material or a flexible material (having the unprintable property). The refractive index of the transparent positioning layer 140 may be close to the refractive index of the transparent substrate 110 but smaller than the refractive index of each of the transparent optical sphere 130.

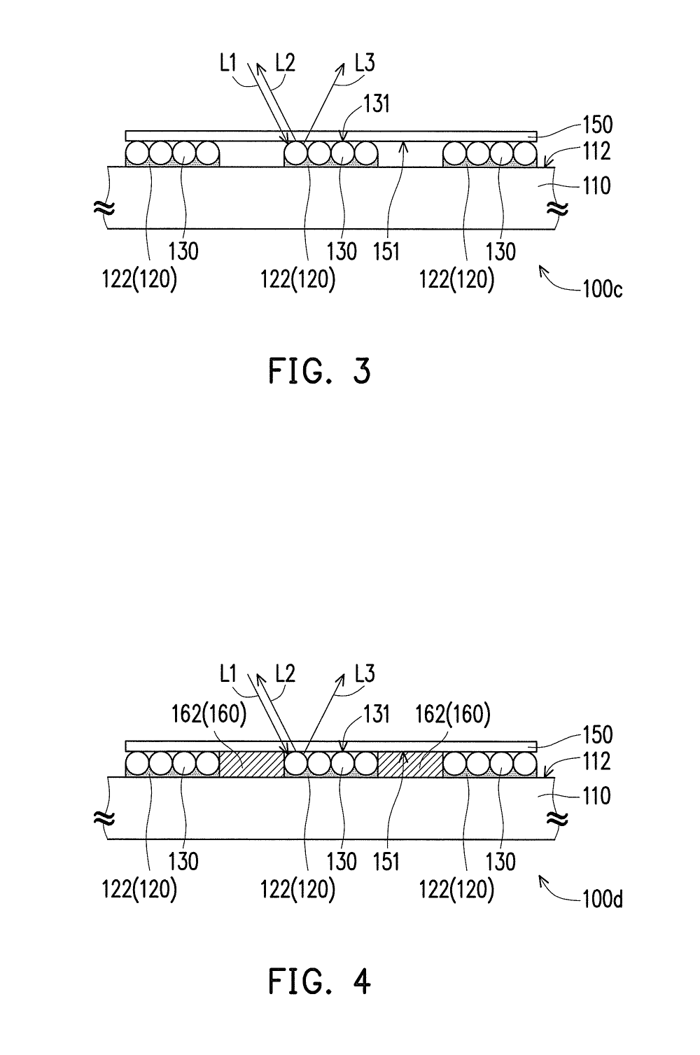

FIG. 3 schematically illustrates a cross-sectional view of an optical touch sensing structure according to another embodiment of the present invention. Referring to FIG. 3, the optical touch sensing structure 100c is similar to the optical touch sensing structure 100a of FIG. 1, and the main differences are described as follows. The optical touch sensing structure 100c further includes a transparent protection layer 150 disposed over the transparent optical spheres 130, and a bottom surface 151 of the protection layer 150 touches a top end 131 of each transparent optical sphere 130. The refractive index of the transparent protection layer 150 is smaller than the refractive index of each of the transparent optical sphere 130. Herein, the thickness of the transparent protection layer 150 ranges from 0.1 millimeter to 1 millimeter. The transparent protection layer 150 protects the transparent optical spheres 130 so that the top end 131 of the transparent optical sphere 130 will not be scratched and the structure of the optical sphere will not be damaged during the operation of the touch device (such as an optical touch stylus). There is the air space existing between the two adjacent adhesive portions 122 and no other component is disposed in the space between the two adjacent adhesive portions. Hence, the visible light can directly pass through the transparent protection layer 150 and the transparent substrate 110.

FIG. 4 schematically illustrates a cross-sectional view of an optical touch sensing structure according to one embodiment of the present invention. Referring to FIG. 4, the optical touch sensing structure 100d is similar to the optical touch sensing structure 100c of FIG. 3, and the main differences are described as follows. The optical touch sensing structure 100d further includes a transparent optical matching layer 160 disposed on the top surface 112 of the transparent substrate 110. The transparent optical matching layer 160 includes a plurality of transparent optical matching portions 162. The transparent optical matching portions 162 covers the top surface 112 of the transparent substrate 110 that is exposed by the adhesive portions 122 of the transparent adhesive layer 120. That is, the adhesive portions 122 and the transparent optical matching portions 162 completely cover the entire top surface 112 of the transparent substrate 110, and the transparent optical matching portions 162 also restrict the locations of the transparent optical spheres 130 on the adhesive portions 122. Herein, the refractive index of the optical matching portions 162 may be close to the refractive index of the transparent substrate 110 and the refractive index of the transparent protection layer 150. Hence, when the optical touch sensing structure 100d is applied in front of the display panel, the overall transmission brightness of the display image is improved.

In summary, as the optical touch sensing structure of the present invention has transparent optical spheres, when a touch device (such as an optical touch stylus) emits an infrared ray to the optical touch sensing structure, the transparent optical spheres can retroreflect and reflect the infrared ray to the infrared camera of the touch device, so as to calculate the position of the touching point(s). Hence, it is not necessary to limit the incident angle of the infrared ray of the touch device or the positions of the infrared camera. As a result, when the touch device works with the optical touch sensing structure of this invention, the touch device can work with a larger range of operation angles and better operation flexibility.

This invention has been disclosed above in several embodiments, but is not limited to those. It is known to persons skilled in the art that some modifications and innovations may be made without departing from the spirit and scope of this invention. Hence, the scope of this invention should be defined by the following claims.

What is claimed is:

1. An optical touch sensing structure, comprising:
a transparent substrate, wherein the transparent substrate includes a top surface;
a transparent adhesive layer, disposed on the top surface of the transparent substrate, wherein the transparent adhesive layer includes a plurality of adhesive portions and the plurality of adhesive portions is separate from one another and exposes a portion of the top surface; and
a plurality of transparent optical spheres, disposed on the plurality of adhesive portions, wherein the plurality of transparent optical spheres is arranged at each of the plurality of adhesive portions as a single layer, and the plurality of transparent optical spheres is fixed on the transparent substrate via the plurality of adhesive portions, so that when an infrared ray reaches each of the plurality of transparent optical spheres, the infrared ray is retroreflected and reflected by each of the plurality of transparent optical spheres.

2. The optical touch sensing structure as recited in claim 1, wherein a refractive index of each of the plurality of transparent optical spheres ranges from 1.9 to 5.0, and a refractive index of each of the plurality of transparent optical spheres is greater than a refractive index of the transparent substrate.

3. The optical touch sensing structure as recited in claim 1, wherein a diameter of each of the plurality of transparent optical spheres ranges from 10 microns to 100 microns.

4. The optical touch sensing structure as recited in claim 1, wherein a material of each of the plurality of transparent optical spheres includes a transparent oxide material.

5. The optical touch sensing structure as recited in claim 1, further comprising a transparent positioning layer disposed on the top surface of the transparent substrate, wherein the transparent positioning layer includes a plurality of transparent positioning portions covering the portion of the top surface that is exposed by the plurality of adhesive portions, and the plurality of transparent positioning portions restrict locations of the plurality of transparent optical spheres on the plurality of adhesive portions, a refractive index of the transparent positioning layer is smaller than a refractive index of each of the plurality of transparent optical spheres.

6. The optical touch sensing structure as recited in claim 5, wherein a top surface of each of the plurality of transparent positioning portion is lower than a top end of each of the plurality of transparent optical spheres, and a material of the transparent positioning layer includes an ultraviolet photoresist material or a flexible material.

7. The optical touch sensing structure as recited in claim 1, further comprising a transparent protection layer disposed over the plurality of transparent optical spheres, wherein a bottom surface of the transparent protection layer is in contact with a top end of each of the plurality of transparent optical spheres.

8. The optical touch sensing structure as recited in claim 7, wherein a refractive index of the transparent protection layer is smaller than a refractive index of each of the plurality of transparent optical spheres, and a thickness of the transparent protection layer ranges from 0.1 millimeter to 1 millimeter.

9. The optical touch sensing structure as recited in claim 7, further comprising a transparent optical matching layer disposed on the top surface of the transparent substrate, wherein a refractive index of the transparent optical matching layer is smaller than a refractive index of each of the plurality of transparent optical spheres, the transparent optical matching layer includes a plurality of transparent optical matching portions covering the portion of the top surface that is exposed by the plurality of adhesive portions.

10. The optical touch sensing structure as recited in claim 9, wherein the transparent protection layer is in contact with a top surface of each of the plurality of transparent optical matching portions.
